(19) United States
(12) Patent Application Publication
(10) Pub. No.: US 2012/0303170 A1
(43) Pub. Date: Nov. 29, 2012

(54) APPARATUS AND METHOD FOR CONTROLLING AND SIMULATING ELECTRIC POWER SYSTEM

(75) Inventors: Taminori TOMITA, Yamato (JP); Yasushi TOMITA, Mito (JP)

(73) Assignee: HITACHI, LTD.

(21) Appl. No.: 13/316,732

(22) Filed: Dec. 12, 2011

(30) Foreign Application Priority Data
May 25, 2011 (JP) 2011-116475

(51) Int. Cl. G06F 19/00

(52) U.S. Cl. 700/286

(57) ABSTRACT

A power system power flow simulator includes a power system power flow calculator using load power in local voltage transformers to calculate power flow in power system extending from a transformer substation to local power transformers, customer load imitators which calculate time change of load power used by customers, dispersed power source imitators which calculate time change of power generated by dispersed power sources and a system status manager which manages operation procedure. The system status manager advances processing while supplying a load power request message with time information attached thereto to the customer load imitators and the dispersed power source imitators, and decides time intervals of supply of the load power request message in accordance with the power load temporal change rate calculated by the customer load imitators and the dispersed power source imitators.

### BACKGROUND OF THE INVENTION

The present invention relates to an apparatus and method for controlling and simulating electric power system and more particularly to a system status operation device, a system controller, a system status operation system, a power distribution system power flow (PF) simulator, a system status operation method, a system control method, a power distribution system power flow simulation method and programs thereof.

Generally, in a power distribution system, a transformer substation at the end of high-voltage power transmission line is connected through local power transformers to electric power customers (customers). The customers contain ordinary houses provided with solar power generators and factories provided with in-house power generators (cogeneration). Voltage of the power distribution system is influenced by not only loads of customers but also power generation amount of dispersed power sources. Accordingly, in order to obtain voltage values at places in power distribution system, as disclosed in JP-A-2004-56996, for example, there is considered technique in which voltage distribution in power line extending from transformer substation to customers is calculated in consideration of loads of customers and reverse power flow power from customers.

### SUMMARY OF THE INVENTION

In recent years, introduction of power generator facilities utilizing natural energy such as sunlight or solar energy and wind power is being extended into customers such as ordinary houses. When electric power sent to power system as reverse power flow power is increased due to such extension, it becomes a large disturbance factor for management of voltage. Furthermore, the reverse power flow power is produced by natural energy and accordingly it is easily changed due to influence of weather.

The operation technique of power system status disclosed in JP-A-2004-56996 does not consider change of use power due to individual factors of a large number of customers such as ordinary houses and change of reverse power flow power due to natural energy such as solar energy and wind power which is used in power generators introduced in customers and accordingly it is difficult to calculate power system status properly.

It is an object of the present invention to provide a system status operation device, a system controller, a system status operation system, a power distribution system power flow simulator, a system status operation method, a system control method, a power distribution system power flow simulation method and programs thereof capable of improving operation accuracy of power system status in consideration of use power and reverse power flow power of a large number of customers.

In order to achieve the above object, according to the present invention, the system status operation device comprises an information obtaining part to obtain information of power amounts of power flow or reverse power flow in plural customers on service lines branched at plural local power transformers from power line at frequency according to change amount of the power amounts and an operation part to calculate voltage condition at predetermined points on the power line on the basis of the information of the obtained plural power amounts.

Further, the power distribution system power flow simulator which simulates power flow in power distribution system extending from a transformer substation through local power transformers to customer loads, comprises:

(1) a power distribution system power flow calculator using load power in the local power transformers to calculate power flow in power distribution system extending from the transformer substation to the local power transformers;
(2) plural customer load imitators to imitate time change of load power used by plural customers individually;
(3) plural dispersed power source imitators to imitate time change of power generated by plural dispersed power sources individually; and
(4) a system status manager which supplies a load power request message containing time information to the customer load imitators and the dispersed power source imitators and obtains response information containing load power at time indicated by the time information from the customer load imitators and the dispersed power source imitators, the system status manager using the obtained load power to calculate load power at plural local power transformers disposed in the power distribution system, the system status manager supplying the calculated load power at plural local power transformers to the power distribution system power flow calculator to make the power distribution system power flow calculator execute power flow calculation; and

the system status manager decides time intervals of supply of the load power request message after next time on the basis of response information to the load power request message from the customer load imitators and the dispersed power source imitators.

Further, time intervals of supply of the load power request message, that is, time intervals of calculation of power load in the customer load imitators and the dispersed power source imitators and power flow calculation in the power distribution system power flow calculator can be decided on the basis of information contained in response messages from the customer load imitators and the dispersed power source imitators. Accordingly, power distribution system power flow simulation can be performed in accordance with actual conditions of load devices and dispersed power sources of customers imitated by individual customer load imitators and dispersed power source imitators as a whole.

According to the present invention, use power and reverse power flow power of a large number of customers can be considered individually to improve accuracy of calculation of status of power system.

Furthermore, there can be provided the power distribution system power flow simulator, the power distribution system power flow simulation method and programs thereof which can consider use power and reverse power flow power of a large number of customers individually.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram illustrating an example of a power system to which a power system power flow simulator according to an embodiment of the present invention is applied;

FIG. 2 is a functional block diagram schematically illustrating an example of the power system power flow simulator according to the embodiment of the present invention;

FIG. 3 is a flow chart showing an example of execution procedure of power system power flow simulation in the power system power flow simulator according to the embodiment of the present invention;

FIG. 4 is a schematic diagram illustrating necessity for executing power flow simulation at intervals according to change situation of load power of load devices and dispersed power sources;

FIG. 5 is a flow chart showing an example of first execution procedure of power flow simulation using master clock and sub-clock by system status manager;

FIG. 6 is a flow chart showing an example of execution procedure obtained by partially modifying the example of the first execution procedure of power flow simulation of FIG. 5;

FIG. 7 is a flow chart showing an example of second execution procedure of power flow simulation using master clock and sub-clock by system status manager;

FIG. 8 is a system diagram schematically illustrating second embodiment according to the present invention;

FIG. 9 is a flow chart showing an example of first execution procedure of the second embodiment;

FIG. 10 is a flow chart showing an example of the first execution procedure of the second embodiment;

FIG. 11 is a flow chart showing modification example of the second embodiment; and

FIG. 12 is a flow chart showing an example of the second execution procedure of the second embodiment.

### DESCRIPTION OF THE EMBODIMENTS

Embodiments of the present invention are now described in detail with reference to the accompanying drawings.

### First Embodiment

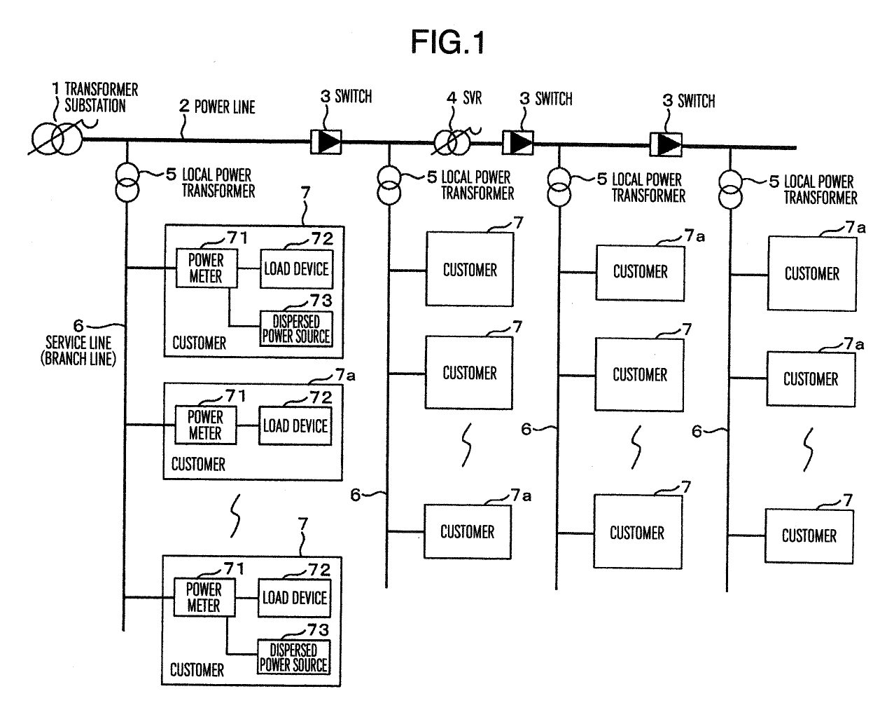

FIG. 1 is a schematic diagram illustrating an example of a power system to which a power system control/power system power flow (PF) simulation according to the embodiment of the present invention is applied. In the embodiment, the power system indicates the power transmission system part from a transformer substation 1 at the end to customers 7, 7a of a power transmission system for connecting power plant to customers for electric power. In power company, power transmission line from transformer substation 1 at the end to local power transformers 5 is named power line 2 and power transmission lines from local power transformers 5 to customers 7, 7a such as ordinary houses are named service lines 6. Generally, voltage on power line 2 is 6.6 kV and voltage on service lines 6 is 100 or 200V.

As shown in FIG. 1, switches 3 for security and trouble measures and step voltage regulator (SVR) 4 for voltage adjustment are connected to power line 2. The SVR 4 is a kind of transformer and is usually connected to power line 2 in a place distant from transformer substation 1. The SVR 4 is commonly used to boost a reduced voltage. Moreover, local power transformers 5 are connected to plural positions branching from power line 2 and plural customers 7, 7a are connected to service lines 6 (also named branch lines) taken out from local power transformers 5. The customer 7 includes a power meter 71, a load device 72 and a dispersed power source 73. Further, the customer 7a includes a power meter 71 and a load device 72 but does not include a dispersed power source 73.

The load device 72 contained in customers 7, 7a collectively includes various home electric appliances such as, for example, illuminators, air conditioners (including a heater-attached table and the like), audio and video apparatuses (televisions, radios and the like), information and communication apparatuses (personal computers, telephones and the like), housework and cooking apparatuses (washing machines, cleaners, microwave ovens and the like). Further, the dispersed power source 73 represents solar power generator, wind power generator, power accumulator and the like.

Furthermore, the power meter 71 is an advanced metering infrastructure (AMI), for example, and has not only the function of measuring forward power flow power and reverse power flow power but also the function of communicating with management server which manages status of power line 2 but is not shown. Moreover, the power meter 71 may have so-called demand side management (DSM) function and may control load device 72 of customer 7 properly to control the amount of used power thereof.

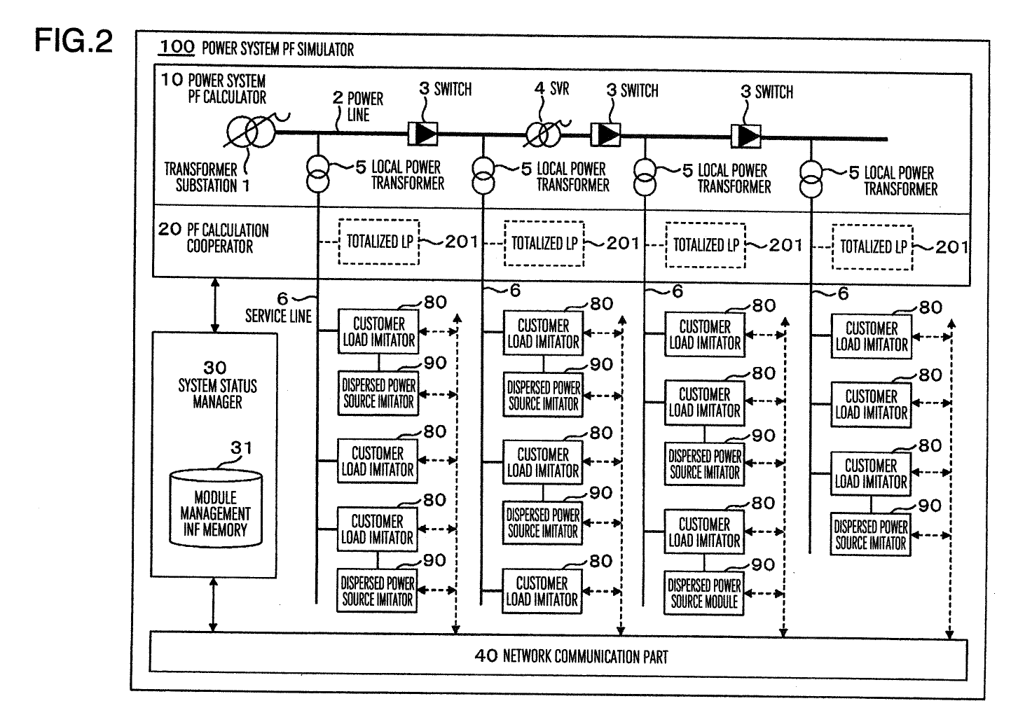

FIG. 2 is a functional block diagram schematically illustrating an example of a power system control/power system power flow simulator according to the embodiment of the present invention. As the embodiment of the present invention, the simulator may be used for power system power flow simulation or when it is used for power system control, part of functional blocks of the power system power flow simulator may be replaced by actually measured values and power system may be controlled by using the replaced power system power flow simulator.

As shown in FIG. 2, the power system power flow simulator 100 according to the embodiment of the present invention includes functional blocks such as a power system power flow calculator 10, a power flow calculation cooperator 20, a system status manager 30, a network communication part 40, customer load imitators 80 and dispersed power source imitators 90. In FIG. 2, in order to clearly express which parts of power system to be applied the respective functional blocks simulate, parts of the power system shown in FIG. 1 are shown together. When power system is controlled, operation is made using actually measured values. Further, when power system is controlled, power system power flow simulator 100 contains power system controller, for example, and controls the supply of power from transformer substation 1, SVR 4, and switches 3 by using result of the power system power flow simulation.

Referring now to FIG. 2, the function of the functional blocks included in the power system power flow simulator 100 is described.

The power system power flow calculator 10 is a functional block which simulates power flow in power system part extending from transformer substation 1 to local power transformers 5, that is, part of power line 2. Namely, when power system power flow calculator 10 is supplied with load power (LP) about local power transformers 5, power system power flow calculator 10 calculates voltage values at points (containing positions on secondary side of local power transformers 5) on power line 2. The calculation of the voltage value is made in consideration of electrical operation of local power transformers 5, SVR 4 and switches 3.

The power flow simulation in power line 2 performed by the power system power flow calculator 10 as described above is a known technique as described in JP-A-2004-56996, for example. Detailed description about the calculation method of the voltage value is omitted.

The customer load imitators 80 simulate time change of power used by customers 7, 7a in units of a day. When a certain time is inputted, the customer load imitators 80 output meter values (power amounts) of power meters 71 at that time on the basis of simulation result.

The concrete method of realizing the simulation in the customer load imitators 80 may be any method. For example, the customer load imitator 80 may have table in which schedule of using illuminators and home electric appliances according to family structure and living rhythm of customers 7, 7a is stored and may simulate time change of use power on the basis of the schedule. Further, more simply, time change of use power may be prepared as table and use power may be obtained from the table.

The dispersed power source imitators 90 simulate time change of power generated by dispersed power sources 73 such as solar power generators and wind power generators provided in customers 7, 7a in units of a day. When a certain time is inputted, the dispersed power source imitators 90 output meter values of power meters 71 at that time on the basis of simulation result. At this time, meter values of power meters 71 represent power amounts of reverse power flow. In the embodiment, power meters 71 may measure load power amounts (forward power flow) and generated power amounts (reverse power flow) separately at the same time.

The concrete method of realizing the simulation in the dispersed power source imitators 90 may be any method similarly to the customer load imitators 80. For example, the dispersed power source imitators 90 may define change of solar radiation amounts and wind force by means of table or function and may obtain generated power in accordance with the solar radiation amounts and wind force. Further, more simply, time change of generated power may be prepared as table and generated power amount may be obtained from the table.

When the simulator of the embodiment is used for power system control, actually measured values of load in customers and generated power of dispersed power sources measured by power meters 71 are used instead of simulation by customer load imitators 80 and dispersed power source imitators 90. Advanced metering infrastructure (AMI), for example, may be used as power meter 71.

In the embodiment, customer load imitators 80 and dispersed power source imitators 90 are provided in one-to-one correspondence manner to load devices 72 and dispersed power sources 73 of customers 7, 7a to be simulated and load power and generated power in customers 7, 7a are possibly different individually. If customer load imitators 80 use, for example, the schedule table of using illuminators and home electric appliances as described above and simulate time change of use power, contents of the table can be modified to easily change use situation of power for each of customers 7, 7a.

In the embodiment, load devices 72 and dispersed power sources 73 of customers 7, 7a are configured to be connected to any line of service lines 6 branched from power line 2 through local power transformers 5 or be able to be identified. Further, this configuration information is managed by system status manager 30 as described later.

The system status manager 30 has the function of managing execution of simulation in power system power flow calculator 10, customer load imitators 80 and dispersed power source imitators 90 mainly.

That is, system status manager 30 can transmit time information to customer load imitators 80 and dispersed power source imitators 90 through network communication part 40 to make them execute simulation, so that system status manager 30 can read out meter values of power meters 71 from customer load imitators 80 and dispersed power source imitators 90.

Further, system status manager 30 totalizes meter values of power meters 71 read out from customer load imitators 80 and dispersed power source imitators 90 for each of service lines 6 connected to them and calculates load power (totalized load power 201) for local power transformers 5 connected to service lines 6. The totalized load power 201 is supplied to power system power flow calculator 10 through power flow calculation cooperator 20, so that power system power flow calculator 10 is requested to execute simulation of power flow.

Moreover, system status manager 30 obtains voltage values at local power transformers 5 obtained as a result of simulation in power system power flow calculator 10, that is, voltage values on service lines 6 and transmits the obtained voltage values on service lines 6 to customer load imitators 80 and dispersed power source imitators 90 through network communication part 40.

Power flow calculation cooperator 20 has the function of matching interface of information transmitted and received between power system power flow calculator 10 and customer load imitators 80 and between power system power flow calculator 10 and dispersed power source imitators 90, although this function is auxiliary function and accordingly power flow calculation cooperator 20 may be considered to be lower-rank functional block contained in system status manager 30.

Network communication part 40 simulates communication of information between system status manager 30 and customer load imitators 80 and between system status manager 30 and dispersed power source imitators 90. However, its communication protocol is not required to be the same as actual protocol such as, for example, protocol for communication performed between management server not shown and power meters 71 included in customers 7, 7a. The protocol may be simplification of protocol used actually.

As described above, in power system power flow simulator 100 of the embodiment, power flow of power system can be simulated in accordance with actual arrangement of power line 2, local power transformers 5 and service lines 6 for customer load imitators 80 and dispersed power source imitators 90 which can simulate load power and generated power changed variously. Accordingly, simulation of power flow of power system can be performed actually and faithfully.

In the embodiment described above, power system power flow simulator 100 does not perform detailed power flow simulation for service lines 6 and voltages on secondary side of local power transformers 5 are applied to load devices 72 and dispersed power sources 73 of customers 7, 7a, although the same simulation as power system power flow calculator 10 may be applied even to service lines 6 to calculate voltage values at points on service lines 6.

Next, a concrete realization method of power system power flow simulator 100 using computer is described.

Power system power flow simulator 100 configured by functional blocks shown in FIG. 2 can be realized by computer including central processing unit (CPU) and memory such as random access memory (RAM) and hard disk drive. In this case, functional blocks such as power system power flow calculator 10, power flow calculation cooperator 20, system status manager 30, network communication part 40, customer load imitators 80 and dispersed power source imitators 90 are realized by executing programs corresponding to respective functional blocks and stored in the memory by the CPU.

Moreover, in the embodiment, when original purpose of simulation is considered, it is necessary to mount a large number of various customer load imitators 80 and dispersed power source imitators 90 in power system power flow simulator 100. In this case, if power system power flow simulator 100 is realized by one computer, it is considered that processing load of the computer is excessive.

Accordingly, in this case, power system power flow simulator 100 may be realized using plural computers connected to one another through communication network. For example, power system power flow calculator 10 may be realized by first computer, power flow calculation cooperator 20 and system status manager 30 may be realized by second computer, and a large number of customer load imitators 80 and dispersed power source imitators 90 may be realized by fourth and successive plural computers. Plural computers can be used to reduce processing load on computers and shorten simulation time.

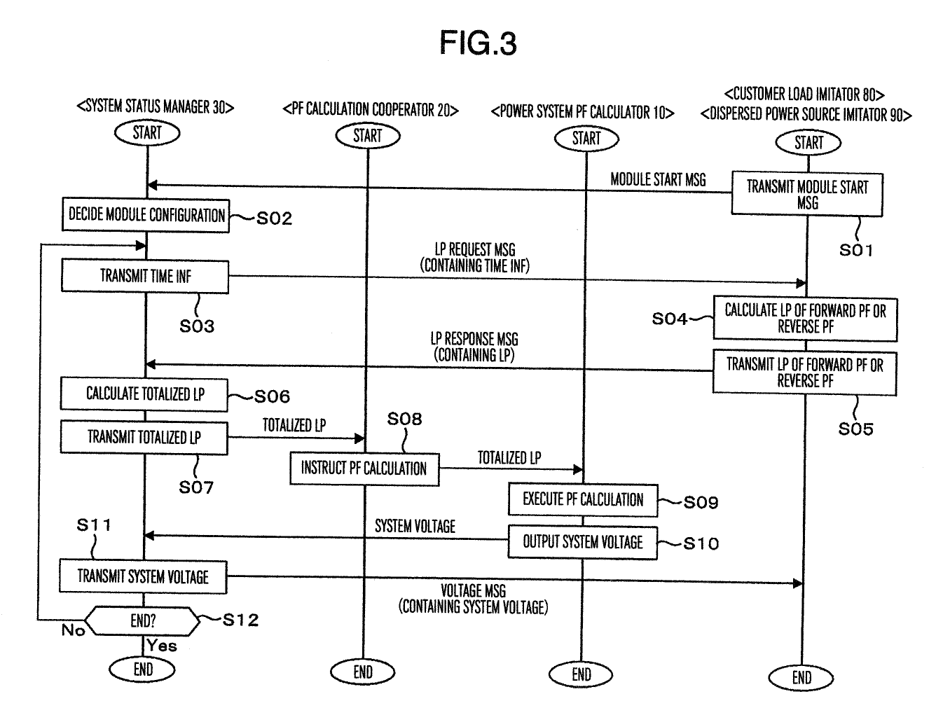

FIG. 3 is a flow chart showing an example of execution procedure of power system power flow simulation in power system power flow simulator 100. As shown in FIG. 3, power system power flow simulation in power system power flow simulator 100 is started by transmitting module start message (msg) to system status manager 30 by customer load imitators 80 and dispersed power source imitators 90 (step S01). In this connection, the module concretely represents each of customer load imitators 80 and dispersed power source imitators 90 included in power system power flow simulator 100. Further, the module start message is message indicating that customer load imitators 80 and dispersed power source imitators 90 start execution of programs of their own modules.

Next, when system status manager 30 receives module start message from customer load imitators 80 and dispersed power source imitators 90, system status manager 30 decides module configuration to be simulated on the basis of received module start message (step S02). The decision of module configuration means that information for specifying modules (customer load imitators 80 and dispersed power source imitators 90) to be managed by system status manager 30 is registered in system status manager 30.

Next, system status manager 30 attaches time information for executing simulation to a load power request message and transmits the load power request message with attached time information (inf) to customer load imitators 80 and dispersed power source imitators 90 to be subjected to simulation management (step S03). The customer load imitators 80 and dispersed power source imitators 90 which have received the time information calculate load power (forward power flow load power) or generated power (reverse power flow load power) (step S04). Hereinafter, in the specification, forward power flow load power and reverse power flow load power are sometimes merely named load power generically. Next, system status manager 30 attaches forward power flow load power or reverse power flow load power calculated in step S04 to load power response message and transmits the message to system status manager 30 (step S05).

Next, when system status manager 30 has received load power transmitted from customer load imitators 80 and dispersed power source imitators 90, system status manager 30 totalizes the received load power for each of service lines 6 and calculates totalized load power 201 (refer to FIG. 2) for local power transformers 5 connected to service lines 6 (step S06). Further, system status manager 30 transmits the totalized load power 201 calculated to power flow calculation cooperator 20 (step S07).

Next, when power flow calculation cooperator 20 has received the totalized load power 201, power flow calculation cooperator 20 instructs power system power flow calculator 10 to perform power flow calculation of power on power line 2 while power flow calculation cooperator 20 transmits the totalized load power 201 to power system power flow calculator 10 (step S08). Power system power flow calculator 10 executes power flow calculation of power instructed (step S09) and as a result power system power flow calculator 10 transmits voltage values (hereinafter referred to as system voltages) at points on power line 2 to system status manager 30 (step S10).

When system status manager 30 has received system voltages from power system power flow calculator 10, system status manager 30 attaches the system voltages (in this case, output voltages on secondary side of local power transformers 5) to voltage message and transmits the voltage message with attached system voltages to customer load imitators 80 and dispersed power source imitators 90 (step S11). System status manager 30 judges whether simulation is ended or not (step S12). When simulation is not ended (No of step S12), processing is returned to step S03 to repeatedly execute processing in step S03 and successive steps. When simulation is ended (Yes of step S12), processing of system status manager 30 is ended.

The series of processing of obtaining load power of customer load imitators 80 and dispersed power source imitators 90 at certain time and then calculating system voltages at that time as described above is generally performed at regular intervals in many cases. In this case, system status manager 30 transmits a load power request message containing time information to customer load imitators 80 and dispersed power source imitators 90 at intervals of 4 minutes, for example, and obtains respective load power so that power system power flow calculator 10 is made to execute simulation of power flow.

Demand houses 7, 7a such as ordinary houses have living rhythm and it is considered that load power in load devices 72 of customers 7, 7a is large changed quite frequently at time zone of meals in the mornings and evenings and before and after the meals, for example, and change of load power is reduced at time zone of daytime. Further, it is considered that change of load power almost disappear at time zone of middle of night and early morning. The same thing is applied even to dispersed power sources 73 such as solar power generators. Accordingly, it is not necessarily said that it is proper to perform simulation of power flow at regular intervals.

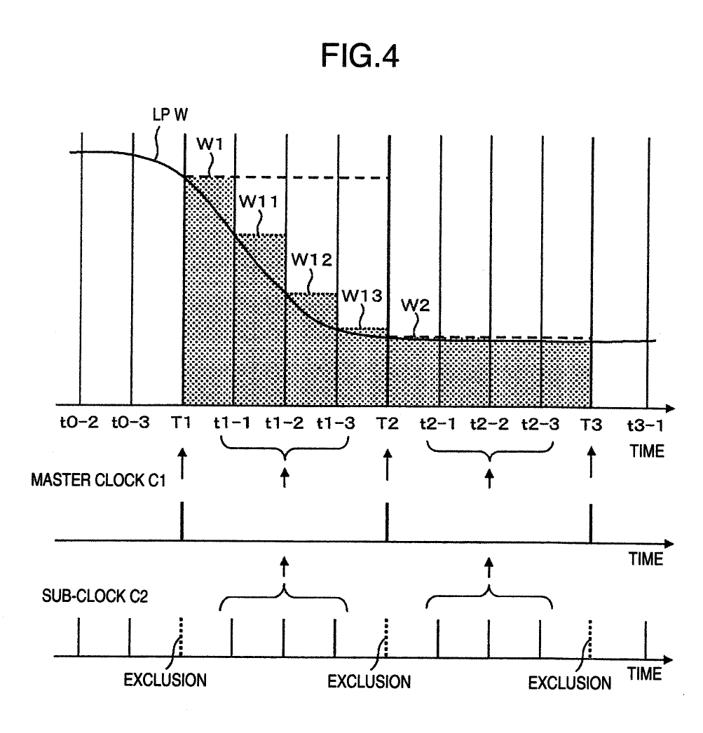

FIG. 4 is a schematic diagram illustrating necessity for executing power flow simulation at intervals according to change situation of load power of load devices 72 and dispersed power sources 73. In order to support easy understanding of description, concept of master clock C1 and sub-clock C2 is introduced. As shown in FIG. 4, master clock C1 is signal for distributing time information at regular intervals of 4 minutes, for example, and sub-clock C2 is signal for distributing time information at intervals of period obtained by dividing period of master clock C1 by 4. The time information described here may be time that clock is generated or may be data indicating time attached to clock message to be provided. Further, when time information of sub-clock C2 overlaps with master clock C1, master clock may take preference at all times, for example. Times T1, T2, T3 . . . described in capital letters represent time generated by master clock C1 and times t1-1, t1-2, t1-3, . . . described in small letters represent time generated by sub-clock C2.

As shown in FIG. 4, when power flow simulation is performed at times T1, T2, T3, . . . of master clock C1, load power W of load devices 72 or dispersed power sources 73 is approximated by broken line of value W1 during times T1 to T2 and load power W obtained at time T2 of master clock C1 is approximated by broken line of value W2 during times T2 to T3. Accordingly, when time change of load power W is larger as compared with period of master clock C1, error of the approximation is large as shown by example between times T1 and T2. In contrast, when time change of load power W is smaller as compared with period of master clock C1, error of the approximation is small as shown by example between times T2 and T3.

Accordingly, in the embodiment, when time change of load power W is larger as compared with period of master clock C1, the series of processing in steps S03 to S11 of power system power flow simulation shown in FIG. 3 is performed by using values W11, W12 and W13 of load power W obtained at times t1-1, t1-2 and t1-3 generated by sub-clock C2 having period shorter than master clock C1. In this case, load power W between times T1 and T2 is approximated by stepwise graph of W1, W11, W12 and W13 and accordingly the accuracy of the approximation is improved.

When the approximation as described above is performed, period of sub-clock C2, that is, division number of period of master clock C1 is desirably changed in accordance with temporal change rate of load power W. Incidentally, in the example of FIG. 4, load power W between times T1 and T2 is interpolated at intervals of sub-clock C2 quartered, although when load power W is interpolated at intervals of sub-clock C2 divided into ten equal parts, the approximation error is reduced. On the other hand, since temporal change rate of load power W between times T2 and T3 is small, load power W may be interpolated at intervals of sub-clock C2 quartered or interpolation using sub-clock C2 may not be performed.

### <Example of First Execution Procedure of Power Flow Simulation>

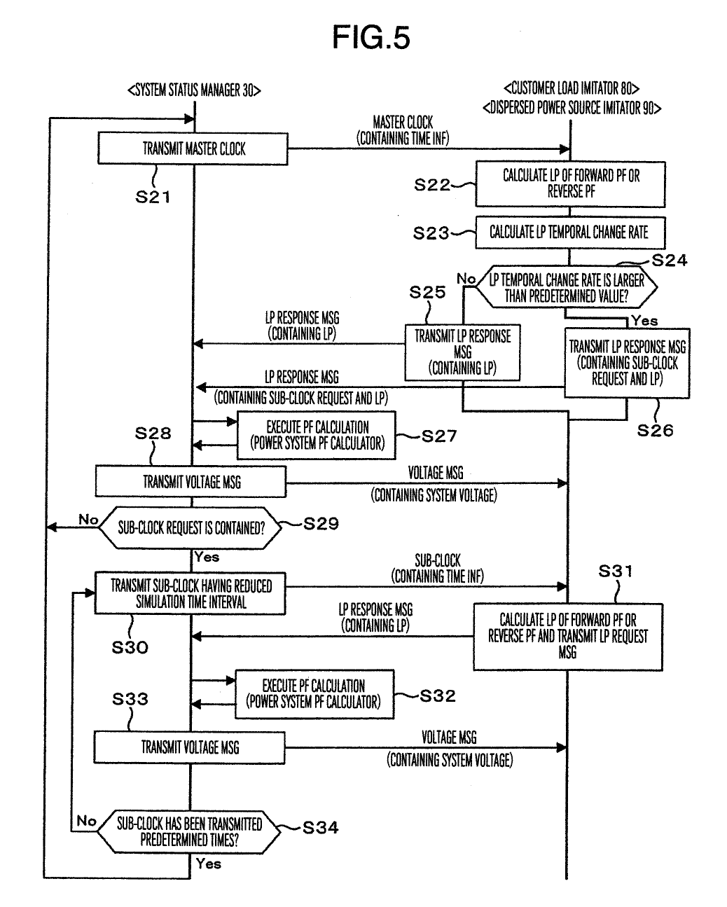

FIG. 5 is a flow chart showing an example of first execution procedure of power flow simulation using master clock C1 and sub-clock C2 by system status manager 30. The execution procedure of this simulation describes operation of system status manager 30, customer load imitators 80 and dispersed power source imitators 90 of execution procedure of power system power flow simulation by the whole power system power flow simulator 100 shown in FIG. 3 in detail while attention is paid to relation between operation of system status manager 30 and operation of customer load imitators 80 and dispersed power source imitators 90.

As shown in FIG. 5, system status manager 30 transmits master clock C1 with time information attached thereto to customer load imitators 80 and dispersed power source imitators 90 (step S21). Demand house load imitators 80 and dispersed power source imitators 90 which have received load request message calculate load power of forward power flow or reverse power flow (step S22).

Demand house load imitators 80 and dispersed power source imitators 90 calculate load power temporal change rate ΔW/ΔT from load power W calculated in step S22 and the last load power Wr in accordance with the following expression (step S23).

ΔW/ΔT=(W−Wr)/(T−Tr) expression (1)

where T is time contained in master clock C1 of this time and Tr is time contained in the last master clock.

Calculation of ΔW/ΔT using expression (1) is made by customer load imitators 80 and dispersed power source imitators 90 individually.

Next, customer load imitators 80 and dispersed power source imitators 90 judge whether the calculated load power temporal change rate is larger than predetermined value or not (step S24). The predetermined value for reference of comparison is set for each of customer load imitators 80 and dispersed power source imitators 90 beforehand and can be decided to any value on the basis of characteristics of imitators.

In judgment of step S24, when load power temporal change rate is smaller than or equal to predetermined value (No of step S24), load power response message with the calculated load power attached thereto is transmitted to system status manager 30 (step S25).

On the other hand, in judgment of step S24, when load power temporal change rate is larger than predetermined value (Yes of step S24), transmission request information of sub-clock is attached to load power response message with the calculated load power attached thereto and is transmitted to system status manager 30 (step S26).

Next, as described in FIG. 3, system status manager 30 totalize load power contained in load power response messages received from customer load imitators 80 and dispersed power source imitators 90 for each of service lines 6 to calculate totalized load power 201 and supplies the calculated totalized load power 201 to power system power flow calculator 10 to make power system power flow calculator 10 execute power flow calculation of power in power line 2 (step S27). System status manager 30 obtains voltages at points in power system, that is, system voltages from power system power flow calculator 10 as a result of power flow calculation and transmits voltage message with the obtained system voltages attached thereto to customer load imitators 80 and dispersed power source imitators 90 (step S28).

Next, system status manager 30 judges whether transmission request information of sub-clock is contained in load power response messages received in step S27 (step S29).

As a result of judgment of step S29, when there is no sub-clock transmission request information (No of step S29), system status manager 30 returns processing to step S21 and transmits next master clock C1. That is, the fact that sub-clock transmission request information is not contained in the received load power response message means that the load power has load power temporal change rate smaller than predetermined load power temporal change rate within period range of master clock C1 and accordingly system status manager 30 continuously executes power flow simulation thereafter while transmitting master clock C1.

On the other hand, in judgment of step S29, when sub-clock transmission request information is contained (Yes of step S29), system status manager 30 transmits sub-clock C2 having reduced time intervals to customer load imitators 80 and dispersed power source imitators 90 (step S30). Reduction of time intervals means concretely that system status manager 30 generates sub-clock C2 as shown in FIG. 4 and after this time system status manager 30 outputs sub-clock C2 to advance the processing until time that next master clock C1 is generated is reached. Sub-clock C2 contains time information obtained by adding time to time information of master clock C1 at intervals of period of master clock C1 divided by N. The division number N is a numerical value set in system status manager 30 beforehand.

Next, customer load imitators 80 and dispersed power source imitators 90 which have received sub-clock calculate load power of forward power flow or reverse power flow and transmit load power response message with the calculated load power attached thereto to system status manager 30 (step S31).

Following processing in steps S32 and S33 is the same as described in steps S27 and S28 and description thereof is omitted.

Subsequently to step S33, system status manager 30 judges whether sub-clock C2 has been transmitted predetermined times or not (step S34). As a result of the judgment, when load request message is not transmitted predetermined times (No of step S34), system status manager 30 returns processing to step S30 and transmits next sub-clock C2. On the other hand, when load request message has been transmitted predetermined times (Yes of step S34), system status manager 30 returns processing to step S21 and transmits next master clock C1.

When the simulator of the embodiment is used for power system control, actually measured values of customer load and dispersed power source generation amounts measured by power meters 71 are used instead of simulation of customer load imitators 80 and dispersed power source imitators 90, although in this case power distribution system is controlled on the basis of execution result of power flow calculation of power in power line 2 of power system power flow calculator 10. That is, supply power of transformer substation 1 is controlled to be increased or decreased or SVR 4 is controlled so that voltage change at places of power line 2 falls within predetermined range. Under certain circumstances, switches 3 are controlled.

As described above, according to the embodiment, when load power temporal change rate is large, obtainment of load power in customer load imitators 80 and dispersed power source imitators 90 using sub-clock C2 and calculation of power flow in power system power flow calculator 10 are performed and accordingly power system power flow simulation is performed at intervals of shorter time. Therefore, accuracy of power system power flow simulation can be improved. Judgment as to whether sub-clock C2 is generated is made in customer load imitators 80 and dispersed power source imitators 90 which are sources of producing load and accordingly it can be avoided that calculation processing of system status manager 30 is produced in large quantities and simulation operation is delayed when the number of customer load imitators 80 and dispersed power source imitators 90 is increased.

As another merit of configuration of making judgment in customer load imitators 80 and dispersed power source imitators 90, transmission request of sub-clock can be issued on the basis of standards different from judgment standards described in step S23 using load calculation logic provided in customer load imitators 80 and dispersed power source imitators 90 originally.

Furthermore, the embodiment has been described by taking customer load imitators 80 for imitating customers and dispersed power source imitators 90 for imitating dispersed power sources as an example, although measurement devices for measuring actual customer loads and generated power amounts of dispersed power sources may be used. In this case, power flow simulation based on actual loads and generated power amounts is performed.

When power system control is used, power distribution system is controlled on the basis of execution result of power flow calculation at places of power line 2 of power system power flow calculator 10. That is, supply power of transformer substation 1 is controlled to be increased or decreased or SVR 4 is controlled so that voltage change at places of power line 2 falls within predetermined range. Under certain circumstances, switches 3 are controlled.

### <Modification Example of First Execution Procedure>

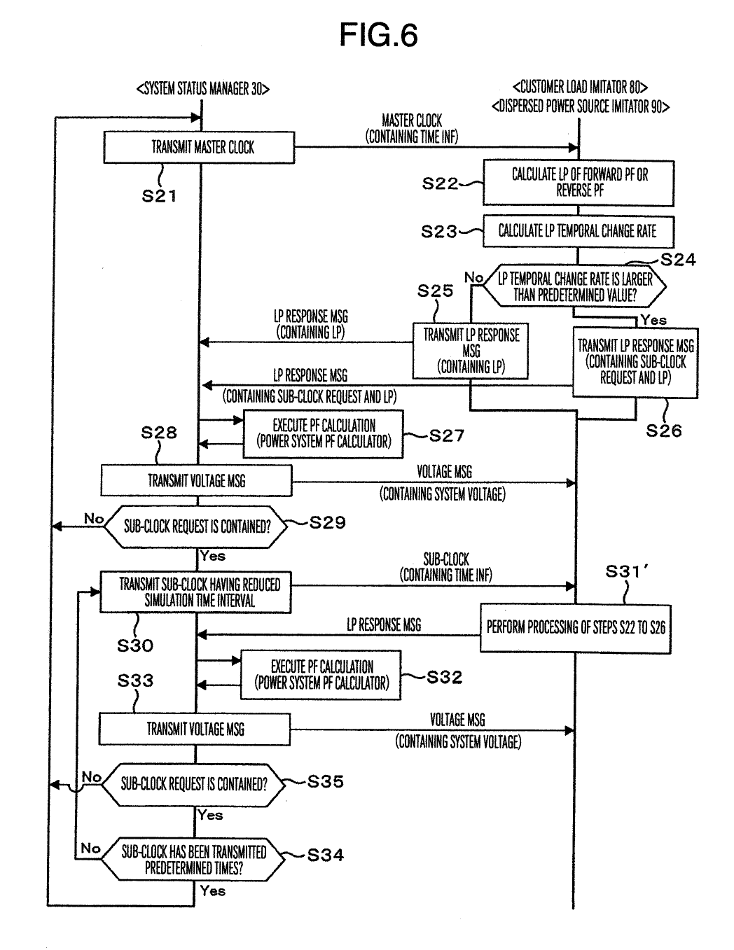

FIG. 6 is a flow chart showing a partial modification example of the first execution procedure of power flow simulation shown in FIG. 5. Most of execution procedure of power flow simulation shown in FIG. 6 is the same as execution procedure shown FIG. 5 but the execution procedure shown in FIG. 6 is different from that of FIG. 5 in that step S31′ in which the same processing as in steps S22 to S26 is performed is added instead of step S31 and step S35 in which the same processing as in step S29 is performed is added after step S33.

That is, in execution procedure shown in FIG. 6, customer load imitators 80 and dispersed power source imitators 90 calculate load power temporal change rate even for load power calculated in accordance with sub-clock C2 and judge whether the load power temporal change rate is larger than predetermined value or not. When the load power temporal change rate is larger than predetermined value, customer load imitators 80 and dispersed power source imitators 90 execute the same processing as in step S26 similarly to the case of FIG. 5. Further, when the load power temporal change rate is smaller than predetermined value, the same processing as in step S25 is performed.

Next, system status manager 30 performs power flow calculation in the same manner as the case of FIG. 5 (step S32) and transmits voltage message (step S33).

Then, in step S35, system status manager 30 performs processing as to whether sub-clock request is present or not similarly to step S29. When there is no transmission request information of sub-clock (No of step S35), system status manager 30 returns processing to step S21 and transmits next master clock C1. On the other hand, when there is transmission request information of sub-clock (Yes of step S29), system status manager 30 advances processing to step S34.

That is, when load power converges to a fixed value in customer load imitators 80 and dispersed power source imitators 90, power flow simulation at intervals of shorter time according to sub-clock C2 is stopped and processing is returned to power flow simulation at intervals of longer time according to master clock C1.

Accordingly, in the modification example of first execution procedure, even when power system power flow simulation is performed at intervals of shorter time according to sub-clock C2, the simulation can be promptly changed to power system power flow simulation at intervals of longer time according to master clock C1 when load power converges to a fixed value. As a result, simulation time can be shortened as a whole and processing load on computer can be reduced.

### <Example of Second Execution Procedure of Power Flow Simulation>

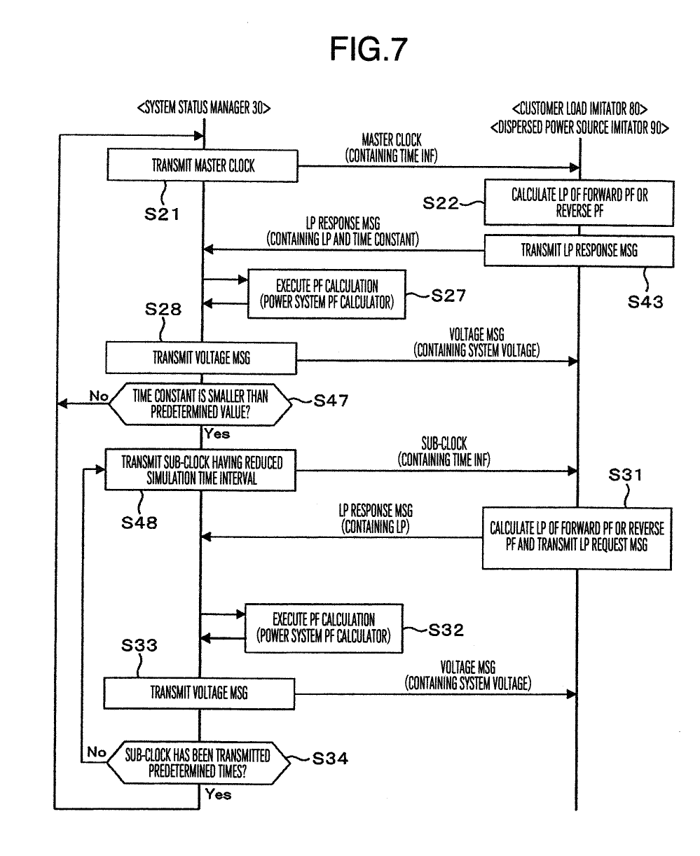

FIG. 7 is a flow chart showing an example of second execution procedure of power flow simulation using master clock C1 and sub-clock C2 by system status manager 30. In this second execution procedure, customer load imitators 80 and dispersed power source imitators 90 attach time constant for change of their own load power to load power response message and transmit the message with time constant attached thereto to system status manager 30.

As shown in FIG. 7, most of the second execution procedure of power flow simulation is the same as first execution procedure shown FIG. 5. Only different part is now described. The same processing as that of FIG. 5 is designated by the same step number.

As shown in FIG. 7, system status manager 30 transmits master clock C1 with time information attached thereto to customer load imitators 80 and dispersed power source imitators 90 (step S21). Next, in the same manner as FIG. 5, load power of forward power flow or reverse power flow is calculated (step S22) and the calculated load power is transmitted to system status manager 30, although at that time in the second execution procedure, customer load imitators 80 and dispersed power source imitators 90 attach time constant of load power change to load power response message together with their own load power and transmit the message to system status manager 30 (step S43).

At this time, customer load imitators 80 and dispersed power source imitators 90 may calculate temporal change rate of load power at time designated by time information contained in load response message and may calculate time constant from the load power temporal change rate. Alternatively, time constants in predetermined time zones may be stored in table beforehand and time constant at designated time may be obtained from the table.

Next, system status manager 30 judges whether time constant attached to load power response message is smaller than predetermined value or not (step S47). The predetermined value for reference of comparison is sufficiently larger than period of master clock C1. Further, time constant to be compared is minimum time constant out of time constants obtained from customer load imitators 80 and dispersed power source imitators 90.

In judgment of step S47, when the time constant is larger than or equal to predetermined value (No of step S47), system status manager 30 returns processing to step S21 and transmits next master clock C1. That is, when time constant is sufficiently larger than period of master clock C1, it means that the load power is not almost changed within range of period of master clock C1. Accordingly, system status manager 30 performs power flow simulation in accordance with master clock C1 even after that.

On the other hand, in judgment of step S47, when the time constant is smaller than predetermined value (Yes of step S47), system status manager 30 shortens transmission time interval of a load power request message (step S48). Shortening of transmission time intervals means that system status manager 30 generates sub-clock C2 as shown in FIG. 4 in the same manner as the case of FIG. 5 and after this time customer load imitators 80 and dispersed power source imitators 90 receive sub-clock C2 to advance processing until next master clock C1 is reached. Further, sub-clock C2 is clock obtained by dividing period of master clock C1 by N. The division number N depends on the time constant and the smaller the time constant is, the larger the division number N is.

The processing from steps S31 to S34 executed by detecting sub-clock C2 is the same as the processing from steps S31 to S34 in FIG. 5.

As described above, in the second execution procedure of power flow simulation, customer load imitators 80 and dispersed power source imitators 90 can judge the intervals of sub-clock in view of respective conditions as compared with first execution procedure and accordingly there is a possibility that accuracy of simulation can be more improved.

### <Modification Example of Second Execution Procedure>

Even in the second execution procedure of power flow simulation, modification can be made in the same manner as the execution procedure shown in FIG. 6, although not shown in drawing. In this case, in step S31 of FIG. 7, customer load imitators 80 and dispersed power source imitators 90 attach time constant to load power response message in accordance with load power. System status manager 30 judges whether the time constant is smaller than predetermined value or not before step S34 and when the time constant is larger than or equal to the predetermined value, the system status manager 30 returns processing to step S21 and outputs next master clock C1.

The predetermined value for reference of comparison is sufficiently larger than period of master clock C1. Accordingly, the purpose of adding the processing is to stop power flow simulation at intervals of shorter time according to sub-clock C2 and return processing to power flow simulation at intervals of longer time according to master clock C1 when time constant is sufficiently longer than period of master clock C1.

Accordingly, even in this case, when load power converges to a fixed value, the processing can be promptly changed to power system power flow simulation performed at intervals of longer time according to master clock C1 even when power system power flow simulation is performed at intervals of shorter time according to sub-clock C2. As a result, simulation time can be shortened as a whole or additional processing of computer can be reduced.

### <Another Modification Example of First Execution Procedure>

There is still another modification example for the first execution procedure of power flow simulation shown in FIGS. 5 and 6. In the first execution procedure of power flow simulation shown in FIGS. 5 and 6, customer load imitators 80 and dispersed power source imitators 90 attach sub-clock request to load power response message, although the attached information may be load power temporal change rate calculated by customer load imitators 80 and dispersed power source imitators 90 instead of sub-clock request.

In this case, system status manager 30 subjects largest load power time temporal rate to processing of step S24 in step S29 and judges distribution of sub-clock.

### Second Embodiment

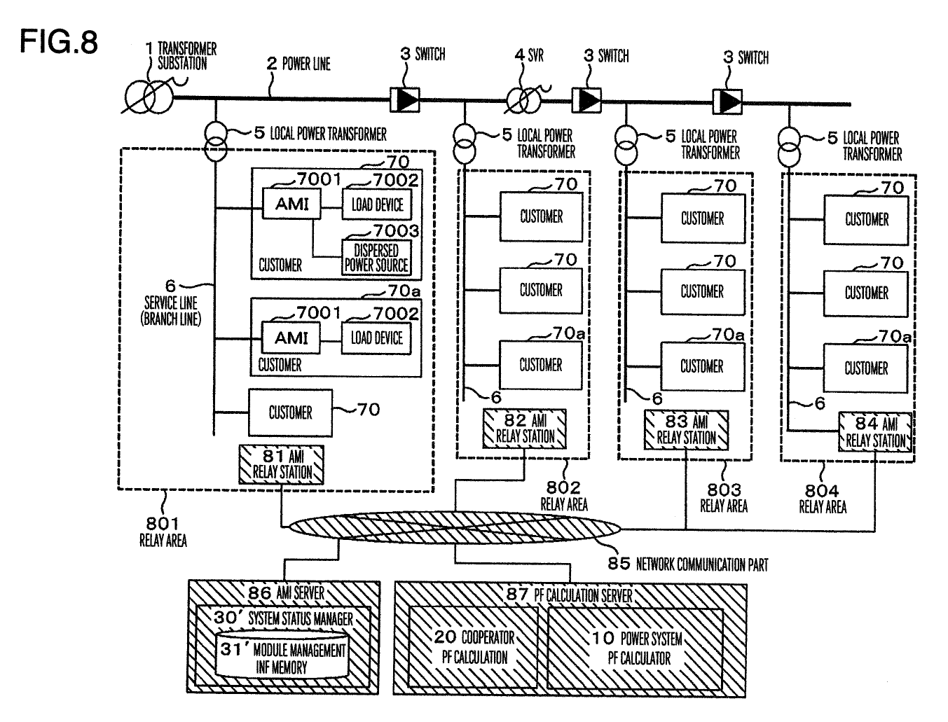

FIG. 8 is a functional block diagram schematically illustrating an example of a power system power flow analysis system according to second embodiment of the present invention. The same elements as those of the first embodiment are given the same reference numerals.

As shown in FIG. 8, power system power flow analysis control system according to the embodiment of the present invention includes AMI's (advanced metering infrastructures) 7001 instead of power meters 71 in the configuration of power system shown in FIG. 1 and includes AMI relay station 81 communicating with AMI's disposed in relay area 801, AMI relay station 82 communicating with AMI's disposed in relay area 802, AMI relay station 83 communicating with AMI's disposed in relay area 803, AMI relay station 84 communicating with AMI's disposed in relay area 804, AMI server 86 for collecting data from AMI's, power flow calculation server 87 for performing power flow calculation processing and network communication part 85 for realizing communication among AMI relay stations, AMI server and power flow calculation server.

AMI's and AMI relay stations are connected by radio by means of a radio system which requires no license, PHS, wireless LAN or the like or connected by means of PLC (power-line carrier).

AMI server 86 includes system status manager 30′. The system status manager 30′ is different from system status manager 30 shown in FIG. 2 in that the system status manager 30′ is connected to AMI's through AMI relay stations and receives power values of load devices and dispersed power sources measured by AMI's.

Further, the AMI server is connected to power flow calculation server 87. The power flow calculation server 87 includes power flow calculation cooperator 20 and power system power flow calculator 10.

In the embodiment, load devices 7002 and dispersed power sources 7003 of customers 70, 70a are connected to any service line 6 branched from power line 2 through local power transformer 5 or are configured to be identifiable.

Moreover, the configuration information is managed by the system status manager 30′.

System status manager 30′ can obtain power values of load devices 7002 and dispersed power sources 7003 from AMI's 7001 through ANTI relay stations.

Further, system status manager 30′ totalizes power values obtained from AMI's 7001 for each of service lines 6 connected thereto and calculates load power on local power transformers 5 connected to service lines 6. The totalized load power is transmitted to power flow calculation server 87 to be supplied to power system power flow calculator 10 through power flow calculation cooperator 20 and power system power flow calculator 10 is required to produce calculation result of power flow.

Power flow calculation cooperator 20 has the function of matching interface of information transmitted and received between power system power flow calculator 10 and AMI's 7001.

Network communication part 85 carries out information communication among AMI server 86, power flow calculation server 87 and AMI relay stations.

As described above, the power system power flow analysis system of the embodiment can use load power and generated power of customers collected by AMI's and changed variously and can analyze power flow of power system in accordance with arrangement of power line 2, local power transformers 5 and service lines 6. Accordingly, power flow of power system can be analyzed precisely.

In the embodiment described above, voltages on secondary side of local power transformers 5 are calculated without performing detailed power flow calculation for part of service lines 6, although the same simulation as power system power flow calculator 10 may be applied to even part of service lines 6 to calculate voltage values at points on service lines 6.

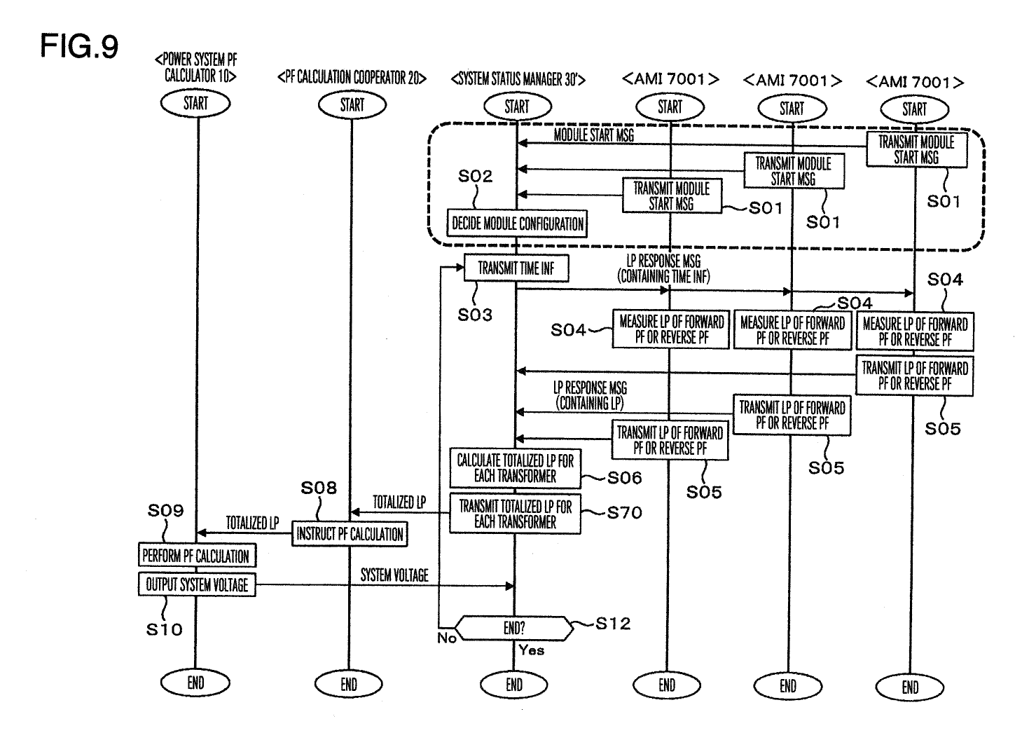

FIG. 9 is a flow chart showing an example of execution procedure of power system power flow analysis in power system power flow analysis system. As shown in FIG. 9, power system power flow analysis in power system power flow analysis system is started by transmitting module start message to system status manager 30 by AMI's 7001 of customers (step S01).

Module represents each of AMI's 7001 concretely. Further, module start message is message indicating that AMI's 7001 are installed in customers and start measurement.

Next, when system status manager 30′ receives module start message from AMI's 7001, system status manager 30′ decides module configuration to be subjected to power flow analysis on the basis of the received module start message (step S02). The decision of module configuration means that information for specifying module (AMI 7001) to be managed by system status manager 30′ is registered in system status manager 30′. Concretely, the information contains information for specifying which position on which service line each AMI is disposed at and is managed in relation to information transmitted from AMI's hereafter.

Next, system status manager 30′ attaches time information that power flow analysis is carried out to a load power request message to be transmitted to AMI's 7001 to be managed (step S03). AMI's 7001 which have received the time information measure load power (load power of forward power flow) or generated power (load power of reverse power flow) at the time (step S04). Hereinafter, in the specification, forward power flow load power and reverse power flow load power are sometimes merely named load power generically.

Next, AMI's 7001 attaches load power of forward power flow or reverse power flow measured in step S04 to load power response message to be transmitted to system status manager 30′ (step S05).

Then, when system status manager 30′ has received load power transmitted from AMI's 7001, system status manager 30′ totalizes the received load power for each of service lines 6 and totals load power for local power transformer connected to service line 6 (step S06). Then, system status manager 30′ transmits the totaled load power for each power transformer to power flow calculation cooperator 20 (step S07).

When power flow calculation cooperator 20 has received totaled load power for each power transformer, power flow calculation cooperator 20 instructs power system power flow calculator 10 to perform power flow calculation of power on power line 2 with the totaled load power attached to instruction (step S08). Power system power flow calculator 10 performs power flow calculation of power instructed (step S09). As a result, power system power flow calculator 10 transmits voltage values (hereinafter referred to as system voltages) at points on power line 2 to system status manager 30′ (step S10).

When system status manager 30′ has received system voltages from power system power flow calculator 10, system status manager 30′ judge whether simulation is ended or not (step S12). When simulation is not ended (No of step S12), the processing is returned to step S03 and the processing after step S03 is repeatedly performed. Further, when simulation is ended (Yes of step S12), processing of system status manager 30′ is ended.

The series of processing of obtaining load power of AMI's 7001 at certain time and then calculating system voltage at that time as described above is generally performed at regular intervals in many cases. In this case, system status manager 30′ transmits a load power request message containing time information to AMI's 7001 at intervals of 4 minutes, for example, and obtains respective load power so that power system power flow calculator 10 is made to execute simulation of power flow.

In the same manner as the case of the first embodiment of the present invention, customers 70, 70a such as ordinary houses have living rhythm and it is considered that load power in load devices 72 of customers 70, 70a is large changed quite frequently at time zone of meals in the mornings and evenings and before and after the meals, for example, and change of load power is reduced at time zone of daytime. Further, it is considered that change of load power almost disappear at time zone of middle of night and early morning. The same thing is applied even to dispersed power sources 73 such as solar power generators. Accordingly, it is not necessarily said that it is proper to perform power flow analysis at regular intervals.

Accordingly, even in the second embodiment of the present invention, it is effective to change time intervals.

### <Example of First Execution Procedure of Power Flow Analysis>

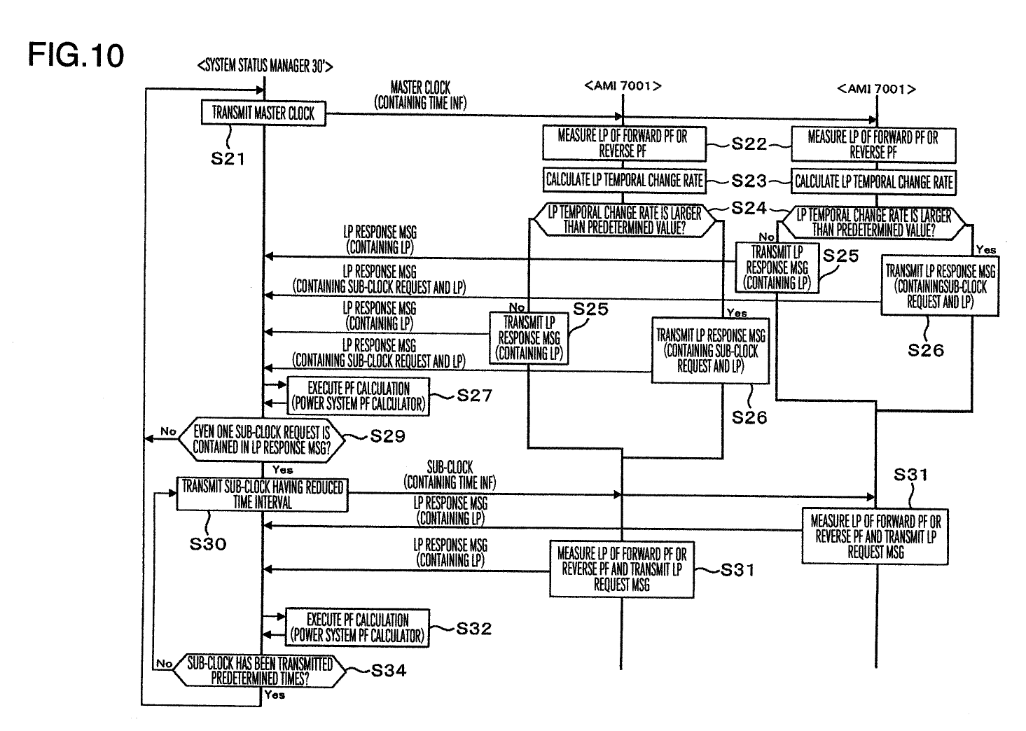

FIG. 10 is a flow chart showing an example of first execution procedure of power flow analysis using master clock C1 and sub-clock C2 by system status manager 30′. This execution procedure of simulation is described in detail while attention is paid to relation between operation of system status manager 30′ and operation of AMI's 7001 of execution procedure of power system power flow analysis by power system power flow analysis system shown in FIG. 8.

As shown in FIG. 10, system status manager 30′ transmits master clock C1 with time information attached thereto to AMI's 7001 (step S21). AMI's 7001 which have received load request message measure load power of forward power flow or reverse power flow at this time (step S22).

Next, AMI's 7001 calculate load power temporal change rate ΔW/ΔT from load power W measured in step S22 and the last load power Wr in accordance with the following expression (step S23).

ΔW/ΔT=(W−Wr)/(T−Tr) expression (1)

where T is time contained in master clock C1 of this time and Tr is time contained in the last master clock.

Calculation of ΔW/ΔT using expression (1) is made by AMI's 7001 individually.

Next, AMI's 7001 judge whether the calculated load power temporal change rate is larger than predetermined value or not (step S24). The predetermined value for reference of comparison is set for each of AMI's 7001 beforehand and may be decided to any value on the basis of characteristics of customers.

In judgment of step S24, when load power temporal change rate is smaller than or equal to predetermined value (No of step S24), load power response message with the measured load power attached thereto is transmitted to system status manager 30′ (step S25).

On the other hand, in judgment of step S24, when load power temporal change rate is larger than predetermined value (Yes of step S24), transmission request information of sub-clock is attached to load power response message with the measured load power attached thereto and is transmitted to system status manager 30′ (step S26).

Next, as described in FIG. 8, system status manager 30′ totalize load power contained in load power response messages received from AMI's 7001 for each of service lines 6 to be supplied to power system power flow calculator 10 to make power system power flow calculator 10 execute power flow calculation of power in power line 2. System status manager 30′ obtains voltages at points in power system, that is, system voltages from power system power flow calculator 10 as a result of power flow calculation (step S27).

Next, system status manager 30′ judges whether sub-clock transmission request information is contained in load power response message received in step S27 (step S29).

As a result of judgment of step S29, when there is no sub-clock transmission request information (No of step S29), system status manager 30′ returns processing to step S21 and transmits next master clock C1. That is, the fact that sub-clock transmission request information is not contained in the received load power response message means that the load power has load power temporal change rate smaller than predetermined load power temporal change rate within period range of master clock C1 and accordingly system status manager 30′ continuously executes power flow analysis thereafter while transmitting master clock C1.

On the other hand, in judgment of step S29, when sub-clock transmission request information is contained (Yes of step S29), system status manager 30′ transmits sub-clock C2 having reduced time intervals to AMI's 7001 (step S30). Reduction of time intervals means concretely that system status manager 30′ generates sub-clock C2 as shown in FIG. 4, and system status manager 30′ outputs sub-clock C2 after this time to advance processing until time that next master clock C1 is generated is reached. Sub-clock C2 contains time information obtained by adding time to time information of master clock C1 at intervals of period of master clock C1 divided by N. The division number N is a numerical value set in system status manager 30′ beforehand.

Next, AMI's 7001 which have received sub-clock calculate load power of forward power flow or reverse power flow and transmit load power response message with the measured load power attached thereto to system status manager 30′ (step S31).

Following processing in step S32 is the same as described in step S27 and description thereof is omitted.

Subsequently to step S32, system status manager 30′ judges whether sub-clock C2 has been transmitted predetermined times or not (step S34). As a result of the judgment, when load request message is not transmitted predetermined times (No of step S34), system status manager 30′ returns processing to step S30 and transmits next sub-clock C2. On the other hand, when load request message has been transmitted predetermined times (Yes of step S34), system status manager 30′ returns processing to step S21 and transmits next master clock C1.

When the system of the embodiment is used for power system control, power distribution system is controlled on the basis of execution result of power flow calculation in power line 2 of power system power flow calculator 10. That is, supply power of transformer substation 1 is controlled to be increased or decreased or SVR 4 is controlled so that voltage change at points of power line 2 falls within predetermined range. Under certain circumstances, switches 3 are controlled.

As described above, according to the embodiment, when load power temporal change rate is large, obtainment of load power in AMI's 7001 using sub-clock C2 and calculation of power flow in power system power flow calculator 10 are performed and accordingly power system power flow analysis is performed at intervals of shorter time. Therefore, accuracy of power system power flow analysis can be improved. Judgment as to whether sub-clock C2 is generated is made in AMI's 7001 which are sources of producing load and accordingly it can be avoided that calculation processing of system status manager 30′ is produced in large quantities and processing is delayed when the number of AMI's 7001 is increased.

As another merit of configuration of making judgment in AMI's 7001, transmission request of sub-clock can be issued on the basis of standards different from judgment standards described in step S23 using judgment logic provided in AMI's 7001 originally.

### <Modification Example of First Execution Procedure>

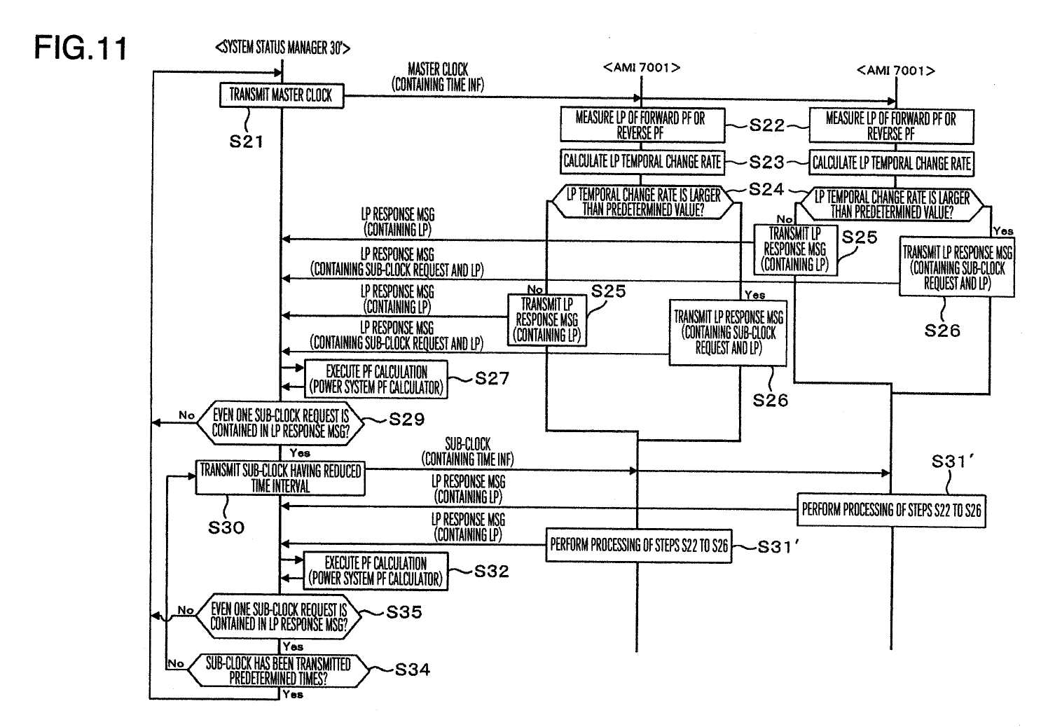

FIG. 11 is a flow chart showing a partial modification example of first execution procedure of power flow analysis shown in FIG. 10. Most of execution procedure of power flow analysis shown in FIG. 11 is the same as execution procedure shown FIG. 10 but the execution procedure shown in FIG. 11 is different from that of FIG. 10 in that step S31′ in which the same processing as in steps S22 to S26 is performed is added instead of step S31 and step S35 in which the same processing as in step S29 is performed is added after step S33.

That is, in execution procedure shown in FIG. 11, AMI's 7001 calculate load power temporal change rate even for load power calculated in accordance with sub-clock C2 and judge whether the load power temporal change rate is larger than predetermined value or not. When the load power temporal change rate is larger than predetermined value, AMI's 7001 execute the same processing as in step S26 similarly to the case of FIG. 10. Further, when the load power temporal change rate is smaller than predetermined value, the same processing as in step S25 is performed.

Next, system status manager 30′ performs power flow calculation in the same manner as the case of FIG. 10 (step S32).

Then, in step S35, system status manager 30′ performs processing as to whether sub-clock request is present or not similarly to step S29. When there is no transmission request information of sub-clock (No of step S35), system status manager 30′ returns processing to step S21 and transmits next master clock C1. On the other hand, when there is transmission request information of sub-clock (Yes of step S29), system status manager 30′ advances the processing to step S34.

That is, when load power converges to a fixed value in AMI's 7001, power flow simulation at intervals of shorter time according to sub-clock C2 is stopped and processing is returned to power flow simulation at intervals of longer time according to master clock C1.

Accordingly, in the modification example of first execution procedure, even when power system power flow analysis is performed at intervals of shorter time according to sub-clock C2, the analysis can be promptly changed to power system power flow analysis at intervals of longer time according to master clock C1 when load power converges to a fixed value. As a result, analysis processing load can be reduced as a whole.

### <Example of Second Execution Procedure of Power Flow Simulation>

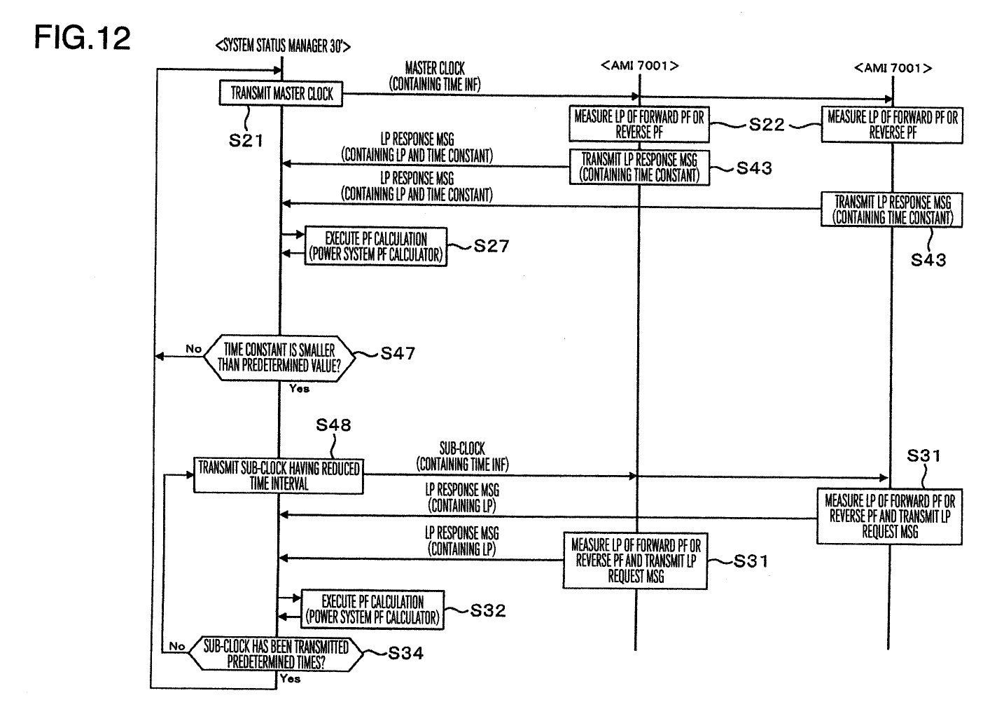

FIG. 12 is a flow chart showing an example of second execution procedure of power flow analysis using master clock C1 and sub-clock C2 by system status manager 30′. In this second execution procedure, AMI's 7001 attach time constant for change of their own load power to load power response message and transmit the message with time constant attached thereto to system status manager 30′.

As shown in FIG. 12, most of the second execution procedure of power flow simulation is the same as first execution procedure shown FIG. 10. Only different part is now described. The same processing as that of FIG. 10 is designated by the same step number.

As shown in FIG. 12, system status manager 30′ transmits master clock C1 with time information attached thereto to AMI's 7001 (step S21). Next, in the same manner as FIG. 10, load power of forward power flow or reverse power flow is measured (step S22) and the measured load power is transmitted to system status manager 30′, although at that time in the second execution procedure, AMI's 7001 attach time constant of load power change to load power response message together with their own load power and transmit the message to system status manager 30′ (step S43).

In this case, AMI's 7001 may calculate load power temporal change rate at time designated by time information contained in load response message and may calculate time constant from the load power temporal change rate. Alternatively, time constants in predetermined time zones may be stored in table beforehand and time constant at designated time may be obtained from the table.

Next, system status manager 30′ judges whether time constant attached to load power response message is smaller than predetermined value or not (step S47). The predetermined value for reference of comparison is sufficiently larger than period of master clock C1. Further, time constant to be compared is minimum time constant out of time constants obtained from AMI's 7001.

In judgment of step S47, when the time constant is larger than or equal to predetermined value (No of step S47), system status manager 30′ returns processing to step S21 and transmits next master clock C1. That is, when time constant is sufficiently larger than period of master clock C1, it means that the load power is not almost changed within range of period of master clock C1. Accordingly, system status manager 30′ performs power flow simulation in accordance with master clock C1 even after that.

On the other hand, in judgment of step S47, when the time constant is smaller than predetermined value (Yes of step S47), system status manager 30′ shortens transmission time intervals of the load power request message (step S48). Shortening of transmission time intervals means that system status manager 30′ generates sub-clock C2 as shown in FIG. 4 in the same manner as the case of FIG. 10 and after this time AMI's 7001 receive sub-clock C2 to advance the processing until next master clock C1 is reached. Further, sub-clock C2 is clock obtained by dividing period of master clock C1 by N. The division number N depends on the time constant and the smaller the time constant is, the larger the division number N is.

The processing from steps S31 to S34 executed by detecting sub-clock C2 is the same as the processing from steps S31 to S34 in FIG. 10.

As described above, in the second execution procedure of power flow simulation, AMI's 7001 can judge the intervals of sub-clock in view of respective conditions as compared with first execution procedure and accordingly there is a possibility that accuracy of power flow analysis can be more improved.

### <Modification Example of Second Execution Procedure>

Even in the second execution procedure of power flow analysis, modification can be made in the same manner as the execution procedure shown in FIG. 11, although not shown in drawing. In this case, in step S31 of FIG. 12, AMI's 7001 attach time constant according to load power to load power response message. System status manager 30′ judges whether the time constant is smaller than predetermined value or not before step S34 and when the time constant is larger than or equal to the predetermined value, the system status manager 30′ returns processing to step S21 and outputs next master clock C1.

The predetermined value for reference of comparison is sufficiently larger than period of master clock C1. Accordingly, the purpose of adding the processing is to stop power flow analysis at intervals of shorter time according to sub-clock C2 and return processing to power flow simulation at intervals of longer time according to master clock C1 when time constant is sufficiently longer than period of master clock C1.

Accordingly, even in this case, when load power converges to a fixed value, the processing can be promptly changed to power system power flow analysis performed at intervals of longer time according to master clock C1 even when power system power flow analysis is performed at intervals of shorter time according to sub-clock C2. As a result, processing load on computer can be reduced as a whole.

### <Another Modification Example of First Execution Procedure>

There is still another modification example for the first execution procedure of power flow analysis shown in FIGS. 10 and 11. In the first execution procedure of power flow analysis shown in FIGS. 10 and 11, AMI's 7001 attach sub-clock request to load power response message, although the attached information may be load power temporal change rate calculated by AMI's 7001 instead of sub-clock request.

In this case, system status manager 30′ subjects largest load power time temporal rate to processing of step S24 in step S29 and judges distribution of sub-clock.

In the execution procedure of the first and second power flow analyses described above, system status manager 30′ transmits master clock and decides measurement time of AMI's 7001, although communication between system status manager 30′ and AMI's 7001 is performed via AMI relay stations. Accordingly, provision of system status manager 30′ in AMI relay stations can perform processing of sub-clock in each of service lines 6 which are within relay area of AMI relay stations, so that data amount passing through network communication part 85 can reduced.

The specification also shows the following devices, systems methods and programs.

1. A system status operation device comprising:

an information obtaining part to obtain information of power amounts of power flow or reverse power flow in plural customers on service lines branched at plural local power transformers from power line at frequency according to change amount of the power amounts and

an operation part to calculate voltage condition at predetermined points on the power line on the basis of the information of the obtained plural power amounts.

2. The system status operation device according to item 1, wherein

information of the power amount is transmitted as power amount at time indicated by time information in response to a power amount request message containing the time information.

3. The system status operation device according to item 2, wherein

interval for the obtainment corresponding the frequency is prescribed and the information of power amount contains information concerning the interval for obtainment.

4. The system status operation device according to item 3, wherein

the information of power amount contains time information concerning transmission of next information of power amount as the information concerning the interval for obtainment.

5. The system status operation device according to item 4, wherein

when the time information concerning transmission of the next information of power amount is transmitted from plural points, shortest time interval of the time is selected.

6. The system status operation device according to item 4, wherein

the change amount is calculated as power amount change rate prescribed by power amount at time indicated by the time information and power amount at predetermined time in the past before the time indicated by the time information and when the power amount change rate is larger than predetermined value, the frequency is set to be increased.

7. The system status operation device according to item 5, wherein

when the power amount change rate is smaller than predetermined value, the frequency is decided to correspond to predetermined maximum interval.

8. A system status operation system including a power distribution status operation part and plural transmission parts, wherein

the power distribution status operation part transmits a power amount request message containing time information to the transmission parts and

each of the plural transmission parts transmits information of power amount of power flow or reverse power flow in customers on service lines branched at plural power transformers from power line at frequency according to change amount of power amount as power amount message in response to the power amount request message,

the power distribution status operation part receiving the power amount message and calculating voltage condition at predetermined points on the power line on the basis of power amount indicated by the received power amount message.

9. The system status operation system according to item 8, wherein

the change amount is calculated in the transmission parts.

10. The system status operation system according to item 9, wherein

the change amount is calculated each time the power amount request message is received.

11. The system status operation system according to item 10, wherein

the change amount is calculated by the power distribution status operation part.

12. A system controller comprising:

an information obtaining part to obtain information of power amounts of power flow or reverse power flow in plural customers on service lines branched at plural local power transformers from power line at frequency according to change amount of the power amounts;

an operation part to calculate voltage condition at predetermined points on the power line on the basis of the information of the obtained plural power amounts; and

a control part to control voltage of the system on the basis of operation result.

13. A power distribution system power flow simulator which simulates power flow in power distribution system extending from a transformer substation through local power transformers to customer loads, comprising:

a power distribution system power flow calculator using load power in the local power transformers to calculate power flow of power in power distribution system part extending from the transformer substation to the local power transformers;

plural customer load imitators to imitate time change of load power of forward power flow which is power used by plural customers individually;

plural dispersed power source imitators to imitate time change of load power of reverse power flow which is power generated by plural dispersed power sources individually; and

a system status manager which supplies a load power request message containing time information to the customer load imitators and the dispersed power source imitators and obtains information containing load power at time indicated by the time information from the customer load imitators and the dispersed power source imitators as response information thereto, the system status manager using the obtained load power to calculate load power at plural local power transformers disposed in the power distribution system, the system status manager supplying the calculated load power at local power transformers to the power distribution system power flow calculator to make the power distribution system power flow calculator execute power flow calculation;

the customer load imitators and the dispersed power source imitators transmitting information deciding time intervals of supply of the load power request message after next time to the system status manager as response information to the load power request message;

the system status manager deciding the time intervals of supply after next time on the basis of information deciding the time intervals of supply.

14. The power distribution system power flow simulator according to item 13, wherein

the customer load imitators and the dispersed power source imitators calculate load power temporal change rates in the customer load imitators and the dispersed power source imitators on the basis of load power at time indicated by the time information and load power at time before the time indicated by the time information and

transmit the calculated load power temporal change rates to the system status manager as information deciding the time intervals of supply.

15. The power distribution system power flow simulator according to item 13, wherein

the customer load imitators and the dispersed power source imitators make the information deciding the time intervals of supply be contained into response information to the load power request message to be transmitted to the system status manager.

16. The power distribution system power flow simulation according to item 13, wherein

when maximum load power temporal change rate is smaller than predetermined value, the customer load imitators and the dispersed power source imitators stop transmission of the information deciding the time intervals of supply of the load power request message or transmit information deciding predetermined maximum time intervals to the system status manager and

the system status manager changes the time intervals of supply after next time to the predetermined maximum time intervals when the system status manager confirms that all of the customer load imitators and the dispersed power source imitators stop transmission of the information deciding the time intervals of supply or the information deciding the predetermined maximum time intervals is transmitted.

17. The power distribution system power flow simulator according to item 13, wherein

the system status manager obtains time constants of time change of load power of the customer load imitators and the dispersed power source imitators from among the response information responded by the customer load imitators and the dispersed power source imitators and

decides time intervals of supply of the load power request message after next time in accordance with minimum time constant of the obtained time constants of time change of load power.

18. A system status operation method comprising:

obtaining information of power amounts of power flow or reverse power flow in plural customers on service lines branched at plural local power transformers from power line at frequency according to change amount of the power amounts and

calculating voltage condition at predetermined points on the power line on the basis of the information of the obtained plural power amounts.

19. A system control method comprising:

obtaining information of power amounts of power flow or reverse power flow in plural customers on service lines branched at plural local power transformers from power line at frequency according to change amount of the power amounts and

calculating voltage condition at predetermined points on the power line on the basis of the information of the obtained plural power amounts.

20. A power distribution system power flow simulation method of simulating power flow in power distribution system extending from a transformer substation through local power transformers to customer loads by computer, wherein

the computer comprises:

a power distribution system power flow calculator using load power in the local power transformers to calculate power flow of power in power distribution system part extending from the transformer substation to the local power transformers;

plural customer load imitators to imitate time change of load power of forward power flow which is power used by plural customers individually;

plural dispersed power source imitators to imitate time change of load power of reverse power flow which is power generated by plural dispersed power sources individually; and

a system status manager to manage processing in the power distribution system power flow calculator, the customer load imitators and the dispersed power source imitators; and

the computer executes, as processing in the system status manager, the following:

processing of supplying a load power request message containing time information to the customer load imitators and the dispersed power source imitators;

processing of obtaining information containing load power at time indicated by the time information from the customer load imitators and the dispersed power source imitators as response information to the load power request message;

processing of calculating load power in plural local power transformers disposed in the power distribution system using the obtained load power;

processing of supplying the calculated load power in the local power transformers to the power distribution system power flow calculator; and

processing of deciding time intervals of supply of the load power request message after next time on the basis of response information to the load power request message from the customer load imitators and the dispersed power source imitators.

21. The power distribution system power flow simulation method according to item 20, wherein

the computer executes, as processing in the customer load imitators and the dispersed power source imitators, the following:

processing of calculating load power temporal change rates in the customer load imitators and the dispersed power source imitators on the basis of load power at time indicated by the time information and load power at time before the time indicated by the time information; and

processing of transmitting information deciding time intervals of supply of the load power request message after next time in accordance with maximum load power temporal change rate of the calculated load power temporal change rates to the system status manager; and

the computer executes, as processing in the system status manager, the following:

processing of deciding time intervals of supply after next time on the basis of information deciding the supply time intervals transmitted from the customer load imitators and the dispersed power source imitators.

22. The power distribution system power flow simulation method according to item 21, wherein

the computer executes, as processing of deciding the supply time intervals after next time, the following:

processing of producing information deciding time intervals of supply of the load power request message after next time to be predetermined maximum time intervals when the maximum load power temporal change rate is smaller than predetermined value.

23. The power distribution system power flow simulation method according to item 20, wherein

the computer executes, as processing of deciding supply time intervals after next time, the following:

processing of obtaining time constants of time change of load power from among the response information responded by the customer load imitators and the dispersed power source imitators and

processing of deciding time intervals of supply of the load power request message after next time in accordance with minimum time constant of the obtained time constants of time change of load power.

24. A program of computer of simulating power flow in power distribution system extending from a transformer substation through local power transformers to customer loads, wherein

the computer comprises:

a power distribution system power flow calculator using load power in the local power transformers to calculate power flow of power in power distribution system part extending from the transformer substation to the local power transformers;

plural customer load imitators to imitate time change of load power of forward power flow which is power used by plural customers individually;

plural dispersed power source imitators to imitate time change of load power of reverse power flow which is power generated by plural dispersed power sources individually; and

a system status manager to manage processing in the power distribution system power flow calculator, the customer load imitators and the dispersed power source imitators; and

the computer is made to execute the following:

processing of supplying a load power request message containing time information to the customer load imitators and the dispersed power source imitators;

processing of obtaining information containing load power at time indicated by the time information from the customer load imitators and the dispersed power source imitators as response information to the load power request message;

processing of calculating load power in plural local power transformers disposed in the power distribution system using the obtained load power;

processing of supplying the calculated load power in the local power transformers to the power distribution system power flow calculator to make the power distribution system power flow calculator execute power flow calculation; and

processing of deciding time intervals of supply of the load power request message after next time on the basis of response information to the load power request message from the customer load imitators and the dispersed power source imitators.

25. The program according to item 24, wherein

the computer is made to execute, as processing in the customer load imitators and the dispersed power source imitators, the following:

processing of calculating load power temporal change rates in the customer load imitators and the dispersed power source imitators on the basis of load power at time indicated by the time information and load power at time before the time indicated by the time information; and

processing of transmitting information deciding time intervals of supply of the load power request message after next time in accordance with maximum load power temporal change rate of the calculated load power temporal change rates to the system status manager; and

the computer is made to execute, as processing in the system status manager, the following:

processing of deciding time intervals of supply after next time on the basis of information deciding the supply time intervals transmitted from the customer load imitators and the dispersed power source imitators.

26. The program according to item 25, wherein

the computer is made to execute, as processing of deciding the supply time intervals after next time, the following:

processing of producing information deciding time intervals of supply of the load power request message after next time to be predetermined maximum time intervals when the maximum load power temporal change rate is smaller than predetermined value.

27. The program according to item 24, wherein

the computer is made to execute, as processing of deciding supply time intervals after next time, the following:

processing of obtaining time constants of time change of load power from among the response information responded by the customer load imitators and the dispersed power source imitators and

processing of deciding time intervals of supply of the load power request message after next time in accordance with minimum time constant of the obtained time constants of time change of load power.

28. A customer load imitator which imitates at least one of time change of load power of forward power flow which is power used by customers and time change of load power of reverse power flow which is power generated by dispersed power sources, comprising

transmission means to receive information containing time supplied externally and transmit response information of load power and generated power at the time,

the transmission means attaching information about time that the information is to be received next to the response information of the load power and generated power to be transmitted.

29. The imitator according to item 28, wherein

the information about time that the information is to be received next is information to control time intervals of information containing time supplied externally.

It should be further understood by those skilled in the art that although the foregoing description has been made on embodiments of the invention, the invention is not limited thereto and various changes and modifications may be made without departing from the spirit of the invention and the scope of the appended claims.

1. A system status operation device comprising:
an information obtaining part to obtain information of power amounts of power flow or reverse power flow in plural customers on service lines branched at plural local power transformers from power line at frequency according to change amount of the power amounts and
an operation part to calculate voltage condition at predetermined points on the power line on the basis of the information of the obtained plural power amounts.

2. The system status operation device according to claim 1, wherein
information of the power amount is transmitted as power amount at time indicated by time information in response to a power amount request message containing the time information.

3. The system status operation device according to claim 2, wherein
interval for the obtainment corresponding the frequency is prescribed and the information of power amount contains information concerning the interval for obtainment.

4. The system status operation device according to claim 3, wherein
the information of power amount contains time information concerning transmission of next information of power amount as the information concerning the interval for obtainment.

5. The system status operation device according to claim 4, wherein
when the time information concerning transmission of the next information of power amount is transmitted from plural points, shortest time interval of the time is selected.

6. The system status operation device according to claim 4, wherein
the change amount is calculated as power amount change rate prescribed by power amount at time indicated by the time information and power amount at predetermined time in the past before the time indicated by the time information and when the power amount change rate is larger than predetermined value, the frequency is set to be increased.

7. The system status operation device according to claim 5, wherein
when the power amount change rate is smaller than predetermined value, the frequency is decided to correspond to predetermined maximum interval.

8. A system status operation system including a power distribution status operation part and plural transmission parts, wherein
the power distribution status operation part transmits a power amount request message containing time information to the transmission parts and
each of the plural transmission parts transmits information of power amount of power flow or reverse power flow in customers on service lines branched at plural power transformers from power line at frequency according to change amount of power amount as power amount message in response to the power amount request message,
the power distribution status operation part receiving the power amount message and calculating voltage condition at predetermined points on the power line on the basis of power amount indicated by the received power amount message.

9. The system status operation system according to claim 8, wherein
the change amount is calculated in the transmission parts.

10. The system status operation system according to claim 9, wherein
the change amount is calculated each time the power amount request message is received.

11. The system status operation system according to claim 10, wherein
the change amount is calculated by the power distribution status operation part.

12. A system controller comprising:
an information obtaining part to obtain information of power amounts of power flow or reverse power flow in plural customers on service lines branched at plural local power transformers from power line at frequency according to change amount of the power amounts;
an operation part to calculate voltage condition at predetermined points on the power line on the basis of the information of the obtained plural power amounts; and
a control part to control voltage of the system on the basis of operation result.

13. A power distribution system power flow simulator which simulates power flow in power distribution system extending from a transformer substation through local power transformers to customer loads, comprising:
a power distribution system power flow calculator using load power in the local power transformers to calculate power flow of power in power distribution system part extending from the transformer substation to the local power transformers;
plural customer load imitators to imitate time change of load power of forward power flow which is power used by plural customers individually;
plural dispersed power source imitators to imitate time change of load power of reverse power flow which is power generated by plural dispersed power sources individually; and
a system status manager which supplies a load power request message containing time information to the customer load imitators and the dispersed power source imitators and obtains information containing load power at time indicated by the time information from the customer load imitators and the dispersed power source imitators as response information thereto, the system status manager using the obtained load power to calculate load power at plural local power transformers disposed in the power distribution system, the system status manager supplying the calculated load power at local power transformers to the power distribution system power flow calculator to make the power distribution system power flow calculator execute power flow calculation;
the customer load imitators and the dispersed power source imitators transmitting information deciding time intervals of supply of the load power request message after next time to the system status manager as response information to the load power request message;
the system status manager deciding the time intervals of supply after next time on the basis of information deciding the time intervals of supply.

14. The power distribution system power flow simulator according to claim 13, wherein
the customer load imitators and the dispersed power source imitators calculate load power temporal change rates in the customer load imitators and the dispersed power source imitators on the basis of load power at time indicated by the time information and load power at time before the time indicated by the time information and
transmit the calculated load power temporal change rates to the system status manager as information deciding the time intervals of supply.

15. The power distribution system power flow simulator according to claim 13, wherein
the customer load imitators and the dispersed power source imitators make the information deciding the time intervals of supply be contained into response information to the load power request message to be transmitted to the system status manager.

16. The power distribution system power flow simulation according to claim 13, wherein
when maximum load power temporal change rate is smaller than predetermined value, the customer load imitators and the dispersed power source imitators stop transmission of the information deciding the time intervals of supply of the load power request message or transmit information deciding predetermined maximum time intervals to the system status manager and
the system status manager changes the time intervals of supply after next time to the predetermined maximum time intervals when the system status manager confirms that all of the customer load imitators and the dispersed power source imitators stop transmission of the information deciding the time intervals of supply or the information deciding the predetermined maximum time intervals is transmitted.

17. The power distribution system power flow simulator according to claim 13, wherein
the system status manager obtains time constants of time change of load power of the customer load imitators and the dispersed power source imitators from among the response information responded by the customer load imitators and the dispersed power source imitators and
decides time intervals of supply of the load power request message after next time in accordance with minimum time constant of the obtained time constants of time change of load power.

18. A system control method comprising:
obtaining information of power amounts of power flow or reverse power flow in plural customers on service lines branched at plural local power transformers from power line at frequency according to change amount of the power amounts and
calculating voltage condition at predetermined points on the power line on the basis of the information of the obtained plural power amounts.

19. A power distribution system power flow simulation method of simulating power flow in power distribution system extending from a transformer substation through local power transformers to customer loads by computer, wherein
the computer comprises:
a power distribution system power flow calculator using load power in the local power transformers to calculate power flow of power in power distribution system part extending from the transformer substation to the local power transformers;
plural customer load imitators to imitate time change of load power of forward power flow which is power used by plural customers individually;
plural dispersed power source imitators to imitate time change of load power of reverse power flow which is power generated by plural dispersed power sources individually; and
a system status manager to manage processing in the power distribution system power flow calculator, the customer load imitators and the dispersed power source imitators; and
the computer executes, as processing in the system status manager, the following:
processing of supplying a load power request message containing time information to the customer load imitators and the dispersed power source imitators;
processing of obtaining information containing load power at time indicated by the time information from the customer load imitators and the dispersed power source imitators as response information to the load power request message;
processing of calculating load power in plural local power transformers disposed in the power distribution system using the obtained load power;
processing of supplying the calculated load power in the local power transformers to the power distribution system power flow calculator; and
processing of deciding time intervals of supply of the load power request message after next time on the basis of response information to the load power request message from the customer load imitators and the dispersed power source imitators.

20. The power distribution system power flow simulation method according to claim 19, wherein
the computer executes, as processing in the customer load imitators and the dispersed power source imitators, the following:
processing of calculating load power temporal change rates in the customer load imitators and the dispersed power source imitators on the basis of load power at time indicated by the time information and load power at time before the time indicated by the time information; and
processing of transmitting information deciding time intervals of supply of the load power request message after next time in accordance with maximum load power temporal change rate of the calculated load power temporal change rates to the system status manager; and
the computer executes, as processing in the system status manager, the following:
processing of deciding time intervals of supply after next time on the basis of information deciding the supply time intervals transmitted from the customer load imitators and the dispersed power source imitators.

21. The power distribution system power flow simulation method according to claim 20, wherein
the computer executes, as processing of deciding the supply time intervals after next time, the following:
processing of producing information deciding time intervals of supply of the load power request message after next time to be predetermined maximum time intervals when the maximum load power temporal change rate is smaller than predetermined value.

22. The power distribution system power flow simulation method according to claim 19, wherein
the computer executes, as processing of deciding supply time intervals after next time, the following:
processing of obtaining time constants of time change of load power from among the response information responded by the customer load imitators and the dispersed power source imitators and
processing of deciding time intervals of supply of the load power request message after next time in accordance with minimum time constant of the obtained time constants of time change of load power.
